(19) United States
(12) Patent Application Publication
(10) Pub. No.: US 2025/0300215 A1
(43) Pub. Date: Sep. 25, 2025

(54) CAN TYPE BATTERY, AND METHOD OF MANUFACTURING CAN TYPE BATTERY

(71) Applicant: HONDA MOTOR CO., LTD., Tokyo (JP)

(72) Inventors: Masahiro Ohta, Wako-shi (JP); Masanari Higuchi, Wako-shi (JP); Atsushi Ogawa, Wako-shi (JP)

(21) Appl. No.: 19/055,572

(22) Filed: Feb. 18, 2025

(30) Foreign Application Priority Data
Mar. 21, 2024 (JP) 2024-045260

(51) Int. Cl. H01M 10/04; H01M 10/058; H01M 50/107; H01M 50/474; H01M 50/48

(52) U.S. Cl. CPC H01M 10/0468; H01M 10/049; H01M 10/058; H01M 50/107; H01M 50/474; H01M 50/48

(57) ABSTRACT

A can type battery includes a can body, an electrode laminate accommodated in the can body and constituted by a positive electrode, a negative electrode and an electrolyte layer, and a holding member disposed in a void between the can body and the electrode laminate and configured to hold the electrode laminate in the can body, and the holding member includes a hollow bead formed of a thermoplastic resin, a metal layer formed on an outer circumferential surface of the hollow bead, and a fluid contained in an internal space of the hollow beads, and is a filling member that includes a metal-coated hollow bead contained in the rubber elastic body, wherein the metal-coated hollow bead or the rubber elastic body has a second volume after heating which is greater than a first volume before heating.

### CROSS-REFERENCE TO RELATED APPLICATION

Priority is claimed on Japanese Patent Application No. 2024-045260, filed Mar. 21, 2024, the content of which is incorporated herein by reference.

### BACKGROUND OF THE INVENTION

### Field of the Invention

The present invention relates to a can type battery, and a method of manufacturing a can type battery.

### Description of Related Art

In sealed batteries, an electrode laminate consisting of a positive electrode, a negative electrode and an electrolyte layer is accommodated within a cylindrical cell. In such a battery, a pressure spacer that applies a pressure to the electrode laminate in a laminating direction is accommodated inside the cell, and the pressure spacer holds the electrode laminate within the cell by deforming in a way that increases an occupied volume within the cell (for example, see Japanese Unexamined Patent Application, First Publication No. H08-83624).

### SUMMARY OF THE INVENTION

The pressure spacer has a problem that it may damage the electrode laminate because it has no mechanism to absorb a dimensional and geometric tolerance of the electrode laminate.

An aspect of the present invention is directed to providing a can type battery in which a holding power of an electrode laminate for a cell is large, and which has a mechanism that absorbs a dimensional tolerance and geometric tolerance of the electrode laminate when pressure is applied to the electrode laminate, and which has a cushioning mechanism that prevents damage to the electrode laminate. Further, an aspect of the present invention is directed to contributing to stabilization of battery performance, improvement of quality management in a manufacturing process, and improvement in energy efficiency.

An aspect of the present invention provides the following configurations.

(1) A can type battery including:
a housing;
an electrode laminate accommodated in a can body and constituted by a positive electrode, a negative electrode and an electrolyte layer; and
a holding member disposed in a void between the can body and the electrode laminate and configured to hold the electrode laminate in the can body,
wherein the holding member includes a hollow bead formed of a thermoplastic resin, a metal layer formed on an outer circumferential surface of the hollow bead, and a fluid contained in an internal space of the hollow beads, and is a filling member that includes a metal-coated hollow bead contained in the rubber elastic body, wherein the metal-coated hollow bead or the rubber elastic body has a second volume after heating which is greater than a first volume before heating.

The holding member can expand due to heating to pressurize the electrode laminate in a laminating direction. When the metal-coated hollow beads are used as the holding member, during expansion, the plurality of metal-coated hollow beads are deformed and move from a place of high stress concentration to a place of low stress concentration, preventing stress from concentrating at the contact parts between the metal-coated hollow beads and the electrode laminate, thereby curbing damage to the electrode laminate. In addition, the deformation of the metal-coated hollow beads can mitigate the expansion or contraction of the electrode laminate during charging/discharging of the battery. Specifically, when the battery is charging, during expansion of the electrode laminate, the surrounding metal-coated hollow beads press down on the electrode laminate, reducing the expansion rate. Further, the plurality of metal-coated hollow beads can absorb the dimensional tolerance and geometric tolerance of the electrode laminate, thereby suppressing damage to the electrode laminate. When a rubber elastic body is used as the holding member, the expansion force of the rubber elastic body can absorb variations in the expansion rate of the individual metal-coated hollow beads, making it possible to form the filling member containing more uniform metal-coated hollow beads, and the holding power of the electrode laminate is further improved by applying a pressure using the uniform filling member. In addition, by covering the electrode surface of the electrode laminate with the rubber elastic body before disposing the electrode laminate inside the can body, the electrode surface of the electrode laminate does not come into direct contact with edges or wall surfaces of the can body, and when impact is applied, the rubber elastic body or the metal-coated hollow beads act as cushioning, thereby reducing damage to the electrode laminate. Since the hollow beads expands due to heating, for example, when the metal-coated hollow beads disposed in the void between two members are heated, the metal-coated hollow beads after expansion pressurize the two members and can hold one member against the other member.

By containing a material in the internal space of the hollow beads that expands the hollow beads by phase change, the hollow beads can easily expand by heating.

The filling member has the rubber elastic body and the metal-coated hollow beads contained within the rubber elastic body, and is therefore capable of standing on its own. In addition, since the metal-coated hollow beads are contained within the rubber elastic body, the rubber elastic body can absorb the variations in the expansion rate of each individual metal-coated hollow bead, forming a more uniform filling member.

(2) The can type battery according to the above-mentioned (1), wherein an insulating body is disposed at least one of between the electrode laminate and the holding member and between the can body and the holding member.

By disposing the insulating body at least one of between the electrode laminate and the holding member and between the can body and the holding member, the insulation between the holding member, the electrode laminate and the can body can be improved.

(3) The can type battery according to the above-mentioned (2), wherein the insulating body is a film or a sheet formed of at least one selected from polyethylene, polypropylene, polyethyleneterephthalate, polyamide, polyamideimide, polyvinylidene fluoride and polytetrafluoroethylene.

By using the insulating body made of a resin with moderate hardness and flexibility, the insulating body can function as a cushioning material and can protect the electrode laminate. Further, if the resin hardness is too high, it can lead to damage to the electrode laminate.

(4) The can type battery according to the above-mentioned (1), wherein the electrolyte layer is a solid electrolyte layer.

When the electrolyte layer is a solid electrolyte layer, the electrode laminate is composed entirely of a solid material, allowing the electrode laminate to stand on its own inside the can body, and after the electrode laminate is inserted inside the can body, the metal-coated hollow beads and the like can be disposed.

(5) The can type battery according to the above-mentioned (1), wherein the fluid is nitrogen gas.

When the fluid is nitrogen gas, in the case in which the battery including the metal-coated hollow beads is increased to a temperature equal to or greater than a predetermined temperature, the metal-coated hollow beads rupture, and thus, the battery is filled with the nitrogen, blocking oxygen, delaying the time to ignition and suppressing the spread of fire caused by ignition. In addition, when the metal-coated hollow beads are used in the can type battery, there is some margin in the space between the can body and the electrode laminate (there is some margin in the space), so when the can-type battery experiences thermal runaway and part of the laminate expands, the hollow beads move to another location to avoid the stress concentration in the expanded area, making it possible to deal with some thermal runaway, thereby improving safety.

(6) The can type battery according to the above-mentioned (1), wherein the hollow bead has an expansion temperature of 100° C. or higher by heating.

Heating to 100° C. or higher causes the fluid in the internal space of the hollow beads to expand, causing the hollow beads to expand.

(7) The can type battery according to the above-mentioned (1), wherein the metal layer contains at least one selected from copper, aluminum, nickel, tin, silver and gold.

When the metal layer contains at least one selected from copper, aluminum, nickel, tin, silver and gold, the heat dissipation and thermal conductance of the metal layer are improved, making it possible to suppress temperature increases, and when the metal-coated hollow beads are heated, the heat is transferred evenly throughout the entire metal-coated hollow beads. In addition, the rigidity of the metal-coated hollow beads also increases, so for example, if the metal-coated hollow beads are placed in the void between the two members and then heated, the metal-coated hollow beads after expansion will pressurize the two members and hold one member against the other member.

(8) The can type battery according to the above-mentioned (1), wherein a thickness of the metal layer is defined by the following Equation (1).

(Thickness of metal layer)/(thickness of outer shell of hollow bead)≤{(Young's Modulus of thermoplastic resin layer)/(Young's Modulus of metal layer)}^{1/3} (1)

By defining the thickness of the metal layer according to the above-mentioned Equation (1), the metal layer also elongates as the hollow beads expand during heating, so that the diameter of the beads can be increased without peeling of the metal layer from the hollow beads.

(9) The can type battery according to the above-mentioned (1), wherein the hollow bead has an average grain diameter (D50) of 50 μm or less before heating, and an average grain diameter (D50) of more than 50 μm and 200 μm or less after heating.

If the average grain diameter (D50) of the hollow beads before heating exceeds 50 μm, for example, when the plurality of metal-coated hollow beads disposed in the void between the two members are heated, the void between the expanded metal-coated hollow beads becomes larger due to heating. For this reason, after expansion, the pressure applied by the metal-coated hollow beads on the two members becomes uneven.

(10) The can type battery according to the above-mentioned (1), wherein the rubber elastic body is constituted by a urethane rubber or a silicone rubber.

Since the rubber elastic body is made of urethane rubber or silicone rubber, the metal-coated hollow beads can be prevented from being crushed inside the rubber elastic body.

(11) The can type battery according to the above-mentioned (1), wherein an elasticity of the rubber elastic body is lower than that of the metal-coated hollow bead.

Since the elasticity of the rubber elastic body is lower than that of the metal-coated hollow beads, the metal-coated hollow beads can be prevented from being crushed within the rubber elastic body.

(12) The can type battery according to the above-mentioned (10) or (11), wherein a thickness of the rubber elastic body is 50 μm or more.

If the thickness of the rubber elastic body is less than 50 μm, the rubber elastic body cannot stand on its own, and folds or creases occur in the rubber elastic body. The folds and creases cause the rubber elastic body to have uneven thickness, which makes it difficult to apply uniform pressure to the laminate during heating, leading to damage to the laminate.

(13) The can type battery according to the above-mentioned (1), wherein a content of the metal-coated hollow bead in the filling member is 40% by volume or more and 80% by volume or less.

When the content of the metal-coated hollow beads in the filling member is less than 40% by volume, they cannot follow the expansion force of the rubber elastic body, and the metal-coated hollow beads cannot expand within the rubber elastic body. When the content of the metal-coated hollow beads in the filling member exceeds 80% by volume, the amount of the rubber elastic body decreases and the filling member cannot stand on its own. In addition, the expansion rate of the filling member can be controlled by adjusting the content of the metal-coated hollow beads.

(14) A method of manufacturing a can type battery including:
a process of disposing an electrode laminate constituted by a positive electrode, a negative electrode and an electrolyte layer in a can body;
a process of disposing a holding member in a void between the can body and the electrode laminate; and
a process of heating and expanding the holding member, pressurizing the electrode laminate against the holding member in a laminating direction, and holding the electrode laminate in the can body with the holding member,
wherein the holding member includes a hollow bead formed of a thermoplastic resin, a metal layer formed on an outer circumferential surface of the hollow bead, and a fluid contained in an internal space of the hollow beads, and is a filling member that includes a metal-coated hollow bead contained in the rubber elastic body, wherein the metal-coated hollow bead or the rubber elastic body has a second volume after heating which is greater than a first volume before heating and, pressurizes the laminate in a laminating direction due to an increase in volume of the metal-coated hollow bead or the rubber elastic body.

The metal-coated hollow beads can expand due to heating to pressurize the electrode laminate in the laminating direction. During expansion, the plurality of metal-coated hollow beads are deformed and move from a place of high stress concentration to a place of low stress concentration, preventing stress from concentrating at the contact parts between the metal-coated hollow beads and the electrode laminate, thereby suppressing damage to the electrode laminate. In addition, the deformation of the metal-coated hollow beads can mitigate the expansion or contraction of the electrode laminate during charging/discharging of the battery. Further, the plurality of metal-coated hollow beads can absorb the dimensional tolerance and geometric tolerance of the electrode laminate, thereby suppressing damage to the electrode laminate.

(15) The method of manufacturing a can type battery according to the above-mentioned (14), further having a process of disposing an insulating body at least one of between the electrode laminate and the holding member and between the can body and the holding member before the process of disposing the electrode laminate.

By disposing the insulating body at least one of between the electrode laminate and the holding member and between the can body and the holding member, before disposing the electrode laminate, damage to the electrode laminate can be suppressed when disposing the electrode laminate inside the can body.

(16) The method of manufacturing a can type battery according to the above-mentioned (14), further having a process of disposing an insulating body configured to cover an electrode surface of the electrode laminate before the process of disposing the electrode laminate.

By disposing the insulating body that covers the electrode surface of the electrode laminate before disposing the electrode laminate, damage to the electrode laminate can be suppressed when the electrode laminate is disposed inside the can body.

According to the present invention, it is possible to provide a can type battery in which a holding power of an electrode laminate for a cell is large, and which has a mechanism that absorbs a dimensional tolerance and geometric tolerance of the electrode laminate when pressure is applied to the electrode laminate, and which has a cushioning mechanism that prevents damage to the electrode laminate.

### BRIEF DESCRIPTION OF THE DRAWINGS

FIG. 1 is a cross-sectional view showing a can type battery according to a first embodiment of the present invention.

FIG. 2 is a cross-sectional view showing a metal-coated hollow bead according to a second embodiment of the present invention.

FIG. 3 is a cross-sectional view showing a filling member according to a third embodiment of the present invention.

FIG. 4 is a cross-sectional view showing a can type battery according to a fourth embodiment of the present invention.

FIG. 5 is a view showing a relationship between a heating temperature of metal-coated hollow beads and an expansion rate of the metal-coated hollow beads in an example.

### DETAILED DESCRIPTION OF THE INVENTION

Hereinafter, embodiments of the present invention will be described in detail with reference to the accompanying drawings.

### [Can Type Battery]

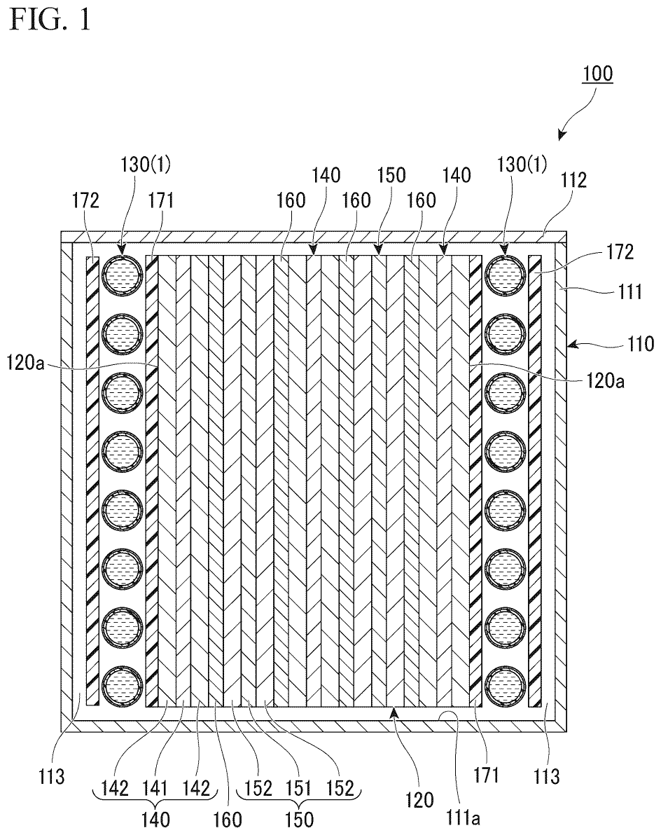

FIG. 1 is a cross-sectional view showing a can type battery according to a first embodiment of the present invention. Further, the drawings used in the following description may be shown with enlarged characteristic parts for the sake of convenience in order to make characteristic parts easier to understand, and dimensional ratios or the like of respective components are not limited to that of illustration.

As shown in FIG. 1, a can type battery 100 of the embodiment includes a can body 110, an electrode laminate 120, and a holding member 130. The electrode laminate 120 is accommodated in the can body 110. The holding member 130 is disposed in a void 113 between the can body 110 and the electrode laminate 120, and holds the electrode laminate 120 in the can body 110.

The can body 110 is a housing that accommodates the electrode laminate 120 and the holding member 130. The can body 110 has a cylindrical main body 111 having a bottom surface 111a, and a lid 112 configured to close an opening portion of the main body 111.

The electrode laminate 120 is constituted by positive electrodes 140, negative electrodes 150 and electrolyte layers 160.

The positive electrodes 140 and the negative electrodes 150 are alternately laminated via the electrolyte layers 160. Charging and discharging of the can type battery 100 are performed by exchange of lithium ions between the positive electrodes 140 and the negative electrodes 150 via the electrolyte layers 160.

### (Positive Electrode)

The positive electrodes 140 are formed by laminating first current collector layers 141 and first active material layers 142 containing at least positive electrode active materials. In the embodiment, the positive electrodes 140 has the first current collector layers 141, and the first active material layers 142 formed on both main surfaces of the first current collector layers 141.

The first current collector layers 141 are preferably composed of at least one material that has high conductance.

Materials with high conductivity include, for example, metals or alloys containing at least one of the following metal elements: silver (Ag), palladium (Pd), gold (Au), platinum (Pt), aluminum (Al), chromium (Cr), and nickel (Ni), or nonmetals made of carbon (C). Considering not only high conductivity but also manufacturing cost, aluminum, nickel or stainless steel are preferable. Further, aluminum does not easily react with the positive electrode active material and the electrolyte. For this reason, when aluminum is used for the first current collector layers 141, the internal resistance of the battery can be reduced.

The shapes of the first current collector layers 141 can include, for example, a foil, a plate shape, a mesh shape, a non-woven fabric shape, a foam shape, and the like. In addition, in order to improve adhesion with the first active material layers 142, carbon or the like may be disposed on the surface of the first current collector layers 141, or the surface may be roughened.

The first active material layers 142 include a positive electrode active material that exchanges lithium ions and electrons. There are no particular limitations on the positive electrode active material, as long as it can reversibly release and absorb lithium ions and is suitable for electron transportation, and any known positive electrode active material that can be used for a positive electrode of a lithium ion battery can be used. For example, compound oxide such as lithium cobalt oxide (LiCoO₂), lithium nickel oxide (LiNiO₂), lithium manganese oxide (LiMn₂O₄), solid solution oxide (Li₂MnO₃-LiMO₂ (M=Co, Ni, or the like)), lithium-manganese-nickel-cobalt oxide (LiNiₓMn_{y}CO₂O₂, x+y+z=1), olivine-type lithium phosphorus oxide (LiFePO₄), or the like; conductivity polymer such as polyaniline, polypyrrole, or the like; sulfide such as Li₂S, CuS, Li-Cu-S compound, TiS₂, FeS, MoS₂, Li-Mo-S compound, or the like; a mixture of sulfur and carbon; and the like, are exemplified. The positive electrode active material may be composed of one of the above materials alone or two or more of them.

The first active material layers 142 contain electrolyte that exchanges lithium ions with the positive electrode active material. There are no particular limitations on the electrolyte as long as it has lithium ion conductivity, and any material generally used for lithium ion batteries can be used. Examples of electrolytes include inorganic solid electrolytes such as a sulfide solid electrolyte material, an oxide solid electrolyte material, a halide solid electrolyte, a lithium-containing salt, and the like, polymer-based solid electrolytes such as polyethylene oxide and the like, gel-based solid electrolytes containing lithium-containing salt or ion liquid with lithium ion conductivity, or the like. Among these, from the viewpoint of the high conductive properties of lithium ions and structural formability by pressing or good interface bonding, a sulfide solid electrolyte material is preferable.

The electrolyte may be composed of one of the above materials alone, or may be composed of two or more of them. The electrolyte contained in the first active material layers 142 may be the same material as the electrolyte contained in a second active material layers 152 or the electrolyte layers 160, or it may be a different material.

The first active material layers 142 may contain conductive additives from the viewpoint of improving the conductivity of the positive electrodes 140. As the conductive additive, any conductive additive that can be used in lithium ion batteries can generally be used. For example, carbon black such as acetylene black, Ketjen black, or the like; carbon fiber; vapor grown carbon fiber; graphite powder; and carbon material such as carbon nano tube or the like, can be exemplified. The conductive additive may consist of one of the above-mentioned materials alone, or two or more of them.

In addition, the first active material layers 142 may include a binder that serves to bind the positive electrode active materials together and to bind the positive electrode active materials to the first current collector layers 141.

In the embodiment, the first active material layers 142 are formed on both the main surfaces of the first current collector layers 141, however, this is not limited thereto, and the first active material layers 142 may be formed on only one main surface of the first current collector layers 141. In addition, when the positive electrodes 140 are one-sided coated electrodes, the laminated positive electrodes, which are made by laminating two positive electrodes so that their current collector surfaces are aligned, may be used as a double-sided coated electrode. First, when the first current collector layers 141 is a 3-dimensional porous structure such as a mesh shape, a non-woven fabric shape, a foam shape, or the like, the first current collector layers 141 may be provided integrally with the first active material layers 142.

The first current collector layers 141 are assembled at one end portion of the can type battery 100 in a widthwise direction.

Since the first active material layers 142 are in contact with the electrolyte layers 160, they may contain sulfide contained in the electrolyte layers 160.

### (Negative Electrode)

The negative electrodes 150 are formed by laminating second current collector layers 151 and second active material layers 152 that contain at least negative electrode active material. In the embodiment, the negative electrodes 150 have the second current collector layers 151, and the second active material layers 152 formed on both main surfaces of the second current collector layers 151 and containing negative electrode active materials and electrolyte.

The second current collector layers 151 contain at least copper (Cu). The second current collector layers 151, like the first current collector layers 141, may contain materials other than copper that have high conductance. Materials other than copper that have high conductivity include, for example, metals or alloys that contain at least one of the metal elements of silver (Ag), palladium (Pd), gold (Au), platinum (Pt), chromium (Cr) and nickel (Ni), or nonmetals made of carbon (C). Considering not only high conductivity but also manufacturing cost, nickel or stainless steel is preferable as materials other than copper. Further, the stainless steel does not react easily with the positive electrode active material, the negative electrode active material and the electrolyte. For this reason, when stainless steel for the second current collector layers 151 is used, the manufacturing costs of the battery can be reduced.

The second current collector layers 151 may have any of a number of shapes, for example, a foil shape, a plate shape, a mesh shape, a non-woven fabric shape, a foam shape, and the like. In addition, in order to improve adhesion with the second active material layers 152, carbon or the like may be disposed on the surface of the second current collector layers 151, or the surface may be roughened.

The second active material layers 152 include a negative electrode active material that exchanges lithium ions and electrons. There are no particular limitations on the negative electrode active material, as long as it can reversibly release and absorb lithium ions and is suitable for electron transportation, and any known negative electrode active material that can be used for the negative electrode of the lithium ion battery can be used. For example, carbonaceous materials such as natural graphite, artificial graphite, resin charcoal, carbon fiber, activated charcoal, hard carbon, soft carbon, and the like; alloy-based materials mainly made of tin, tin alloy, silicon, silicon alloy, gallium, gallium alloy, indium, indium alloy, aluminum, aluminum alloy, or the like; conductivity polymers such as polyacene, polyacetylene, polypyrrole, and the like; metal lithium; lithium titanium compound oxide (for example, Li₄Ti₅O₁₂), and the like, are exemplified. These negative electrode active materials may be composed of one of the above-mentioned materials alone or two or more of them.

The second active material layers 152 contain electrolyte that exchanges lithium ions with the negative electrode active material. There are no particular limitations on the electrolyte as long as it has lithium ion conductivity, and any material generally used for lithium ion batteries can be used. Examples of the electrolytes may include inorganic solid electrolytes such as a sulfide solid electrolyte material, an oxide solid electrolyte material, a halide solid electrolyte, a lithium-containing salt, and the like, polymer-based solid electrolytes such as polyethylene oxide or the like, gel-based solid electrolytes containing lithium-containing salt or ion liquid with lithium ion conductivity, or the like. The electrolyte may be composed of one of the above-mentioned materials alone, or may be composed of two or more of them.

The electrolyte contained in the second active material layers 152 may be the same as or different from the electrolyte contained in the first active material layers 142 or the electrolyte layers 160.

The second active material layer 152 may contain conductive additives, binders, and the like. There are no particular limitations on these materials, but, for example, materials similar to those used for the first active material layers 142 described above can be used.

In the embodiment, the second active material layers 152 are formed on both main surfaces of the second current collector layers 151, however, this is not limited thereto, and the second active material layers 152 may be formed on only one of the main surfaces of the second current collector layers 151. In addition, when the second current collector layers 151 have a three-dimensional porous structure such as a mesh shape, a non-woven fabric shape, a foam shape, or the like, the second current collector layers 151 may be provided integrally with the second active material layers 152.

### (Electrolyte Layer)

The electrolyte layers 160 are disposed between the first active material layers 142 and the second active material layers 152. Then, an area of the electrolyte layer 160 is greater than an area of the first active material layer 142 in the positive electrode 140 in a direction perpendicular to the laminating direction. Accordingly, lithium electrodeposition in the electrode outer circumferential portion can be suppressed.

There are no particular limitations on the electrolyte as long as it has lithium ion conductivity and insulation, and any material generally used for lithium ion batteries can be used. For example, inorganic solid electrolytes such as a sulfide solid electrolyte material, an oxide solid electrolyte material, a halide solid electrolyte, a lithium-containing salt, and the like, polymer-based solid electrolytes such as polyethylene oxide or the like, gel-based electrolyte containing lithium-containing salt or ion liquid of lithium ion conductivity, or the like, can be exemplified. Among these, from the viewpoint of the high conductive properties of lithium ions and structural formability by pressing or good interface bonding, the sulfide solid electrolyte material is preferable.

The form of the electrolyte material is not particularly limited, but may be, for example, in the form of particles. When the electrolyte layers 160 are solid electrolyte layers, the electrode laminate 120 is composed entirely of a solid material, allowing the electrode laminate 120 to stand on its own inside the can body 110, and after the electrode laminate 120 is inserted inside the can body 110, the holding member 130 and the like can be disposed.

The electrolyte layers 160 may include an adhesive agent to impart mechanical strength and flexibility.

The electrolyte layers 160 may be in the form of sheets having a porous substrate and a solid electrolyte supported on the porous substrate. The form of the porous substrate is not particularly limited, but examples include woven fabric, nonwoven fabric, mesh cloth, porous membrane, expanded sheet, punched sheet, or the like. Among these forms, nonwoven fabrics are preferred from the viewpoint of handling properties, which can increase the filling volume of the solid electrolyte.

The porous substrate is preferably made of an insulating material. Accordingly, insulation of the electrolyte layers 160 can be improved. The insulating material includes, for example, a resin material such as nylon, polyester, polyethylene, polypropylene, polytetrafluoroethylene, ethylene-tetrafluoroethylene ethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, acrylic resin, or the like; natural fiber such as hemp, wood pulp, cotton linter, or the like, glass, or the like.

The holding member 130 is made of metal-coated hollow beads 1, the embodiment of which will be described later. That is, the holding member 130 is constituted by the metal-coated hollow beads 1, which have hollow beads made of thermoplastic resin, metal layers formed on the outer circumferential surfaces of the hollow beads, and fluid contained in the internal space of the hollow beads, and whose second volume after heating is larger than a first volume before heating.

As shown in FIG. 1, in the can type battery 100 of the embodiment, a first insulating body 171 is preferably disposed between the electrode laminate 120 and the holding member 130, and a second insulating body 172 is preferably disposed between the can body 110 and the holding member 130. Since the first insulating body 171 is disposed between the electrode laminate 120 and the holding member 130, when the electrode laminate 120 is accommodated in the can body 110, damage to the electrode laminate 120 can be suppressed. Since the second insulating body 172 is disposed between the can body 110 and the holding member 130, it is possible to prevent electricity from flowing to various points and deterioration of conductivity. Further, either the first insulating body 171 or the second insulating body 172 may be provided, or both may be provided.

It is preferable that the first insulating body 171 and the second insulating body 172 are a film or sheet made of at least one material selected from polyethylene, polypropylene, polyethyleneterephthalate, polyamide, polyamideimide, polyvinylidene fluoride and polytetrafluoroethylene. By arranging the first insulating body 171 and the second insulating body 172, which are made of resin having moderate hardness and flexibility, the first insulating body 171 and the second insulating body 172 can function as cushioning materials to protect the electrode laminate 120. Further, if the resin hardness is too high, it will lead to damage to the electrode laminate 120. Further, the first insulating body 171 and the second insulating body 172 may be made of the same material or different materials.

In addition, in the can type battery 100 of the embodiment, the metal-coated hollow beads 1 of the holding member 130 and the substrate layer are preferably adhered via an adhesive agent. Examples of the adhesive agent include urethane-based adhesive agents, acrylic-based adhesive agents, silicon-based adhesive agents, and the like. By using the adhesive agent, the amount of adhesion of the metal-coated hollow beads to the substrate layer can be adjusted within a predetermined range.

In addition, in the can type battery 100 of the embodiment, the first insulating body 171 configured to cover an electrode surface 120a of the electrode laminate 120 is preferably disposed. Damage to the electrode laminate 120 can be suppressed by the first insulating body 171 configured to cover the electrode surface 120a of the electrode laminate 120. In addition, the first insulating body 171 is disposed to cover the electrode surface 120a of the electrode laminate 120, and the second insulating body 172 is disposed between the can body 110 and the holding member 130, thereby improving the insulation between the holding member 130, the electrode laminate 120 and the can body 110. By arranging the first insulating body 171 and the second insulating body 172, conductivity is improved and battery performance is improved.

According to the can type battery 100 of the embodiment, the holding member 130 can expand due to the heating to pressurize the electrode laminate 120 in the laminating direction. When the metal-coated hollow beads 1 are used as the holding member 130, during expansion, the plurality of metal-coated hollow beads 1 are deformed and moved from a place of high stress concentration to a place of low stress concentration, so that stress is not concentrated at the contact parts between the metal-coated hollow beads 1 and the electrode laminate 120, thereby suppressing damage to the electrode laminate 120. In addition, the deformation of the metal-coated hollow beads 1 can mitigate expansion or contraction of the electrode laminate 120 during charging/discharging of the can type battery 100. Specifically, when the electrode laminate 120 expands during charging of the can type battery 100, the surrounding metal-coated hollow beads 1 are pressed down on the electrode laminate 120, thereby reducing the expansion rate. Further, the plurality of metal-coated hollow beads 1 can absorb the dimensional tolerance and geometric tolerance of the electrode laminate 120, thereby preventing damage to the electrode laminate 120. When a rubber elastic body is used as the holding member 130, the expansion force of the rubber elastic body can absorb variations in the expansion rate of the individual metal-coated hollow beads 1, making it possible to form the holding member 130 that contains more uniform metal-coated hollow beads 1, and the holding power of the electrode laminate 120 is further improved by applying pressure using the uniform holding member 130. In addition, by covering the electrode surface 120a of the electrode laminate 120 with a rubber elastic body before disposing the electrode laminate 120 inside the can body 110, the electrode surface 120a of the electrode laminate 120 does not come into direct contact with edges or wall surfaces of the can body 110, and when impact is applied, the rubber elastic body or the metal-coated hollow beads 1 act as cushioning, thereby suppressing damage to the electrode laminate 120.

### [Method of Manufacturing can Type Battery]

A method of manufacturing a can type battery according to an embodiment of the present invention has a process of disposing a electrode laminate constituted by a positive electrode, a negative electrode and an electrolyte layer in a can body (hereinafter, referred to as “a first process”), a process of disposing a holding member in a void between the can body and the electrode laminate (hereinafter, referred to as “a second process”), and a process of heating and expanding the holding member, pressurizing the electrode laminate against the holding member in a laminating direction, and holding the electrode laminate with the holding member in the can body (hereinafter, referred to as “a third process”).

Referring to FIG. 1, the method of manufacturing a can type battery according to the embodiment of the present invention will be described.

In the first process, the electrode laminate 120 is disposed in the main body 111 of the can body 110. Here, in order to prevent the can body 110 and the electrode laminate 120 from coming into direct contact with each other, it is preferable to dispose an insulating member on the bottom surface 111a of the main body 111.

In the second process, the holding member 130 is disposed in the void 113 between the can body 110 and the electrode laminate 120. The holding member 130 is the metal-coated hollow beads 1 of the above-mentioned embodiment or a filling member 10 of the above-mentioned embodiment.

In the third process, the holding member 130 is heated and expanded, and the electrode laminate 120 is pressed in the laminating direction by the holding member 130, so that the electrode laminate 120 is held within the can body 110 by the holding member 130.

The holding member 130 is, for example, the metal-coated hollow beads 1 described below. Since the metal-coated hollow beads 1 have metal layers formed on the outer circumferential surfaces of the hollow beads, there is less contraction when cooled after heating compared to beads without metal layers, and the laminate pressure of the holding member 130 is less likely to decrease.

To heat the holding member 130, for example, a heater such as an electric heater or the like is placed in contact with the outer surface of the can body 110, and the holding member 130 is heated via the can body 110 by the heater.

The holding member 130 is preferably heated at a high temperature for a short time, as long as the temperature does not affect the electrode laminate 120. Specifically, when the holding member 130 is heated to 100° C. or higher, the holding member 130 expands. As a result, the holding member 130 applies a pressure to the electrode laminate 120 in the laminating direction, and the holding member 130 can hold the electrode laminate 120 within the can body 110.

The method of manufacturing a can type battery of the embodiment preferably has at least one of a process of disposing the first insulating body 171 between the electrode laminate 120 and the holding member 130 before the first process, and a process of disposing the second insulating body 172 between the can body 110 and the holding member 130 before the first process. When the electrode laminate 120 is accommodated in the can body 110 by disposing the first insulating body 171 between the electrode laminate 120 and the holding member 130, damage to the electrode laminate 120 can be suppressed. By disposing the second insulating body 172 between the can body 110 and the holding member 130, it is possible to prevent electricity from flowing to various points and deterioration of conductivity.

The method of manufacturing a can type battery of the embodiment preferably has a process of disposing the first insulating body 171 configured to cover the electrode surface 120a of the electrode laminate 120, before the first process. By disposing the first insulating body 171 configured to cover the electrode surface 120a of the electrode laminate 120 before disposing the electrode laminate 120 in the can body 110, when the electrode laminate 120 is disposed in the can body 110, since the electrode laminate 120 does not come into direct contact with the edges or inner walls of the can body 110, damage to the electrode laminate 120 can be suppressed. In addition, since the method of manufacturing a can type battery of the embodiment has a process of disposing the second insulating body 172 between the can body 110 and the holding member 130 before the first process, when the electrode laminate 120 is disposed inside the can body 110, the electrode laminate 120 does not come into direct contact with the edges or inner walls of the can body 110, and damage to the electrode laminate 120 can be suppressed.

According to the method of manufacturing a can type battery of the embodiment, the holding member 130 expands due to the heating to pressurize the electrode laminate 120 in the laminating direction. When the metal-coated hollow beads 1 are used as the holding member 130, during expansion, the plurality of metal-coated hollow beads 1 are deformed and move from a place of high stress concentration to a place of low stress concentration, so that stress is not concentrated at the contact parts between the metal-coated hollow beads 1 and the electrode laminate 120, thereby suppressing damage to the electrode laminate 120. In addition, the deformation of the metal-coated hollow beads 1 can mitigate the expansion or contraction of the electrode laminate 120 during charging/discharging of the battery. Further, the plurality of metal-coated hollow beads 1 can absorb the dimensional tolerance or geometric tolerance of the electrode laminate 120, thereby preventing damage to the electrode laminate 120.

When the rubber elastic body is used as the holding member 130, the expansion force of the rubber elastic body can absorb variations in the expansion rate of the individual metal-coated hollow beads 1, making it possible to form the holding member 130 containing more uniform metal-coated hollow beads 1, and the holding power of the electrode laminate 120 is further improved by applying a pressure using the uniform holding member 130.

In addition, by covering the electrode surface 120a of the electrode laminate 120 with a rubber elastic body before disposing the electrode laminate 120 inside the can body 110, the electrode surface 120a of the electrode laminate 120 does not come into direct contact with the edges or wall surfaces of the can body 110, and when impact is applied, the rubber elastic body or the metal-coated hollow beads 1 act as cushioning, thereby suppressing damage to the electrode laminate 120.

### [Metal-Coated Hollow Beads]

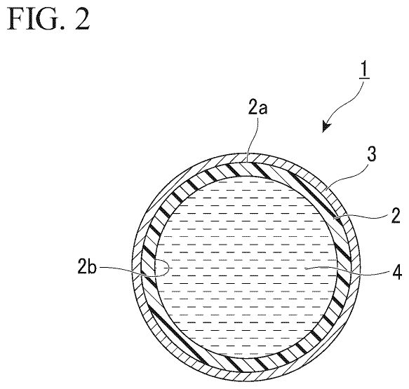

FIG. 2 is a cross-sectional view showing a metal-coated hollow bead according to a second embodiment of the present invention.

As shown in FIG. 2, the metal-coated hollow bead 1 of the embodiment has a hollow bead 2, a metal layer 3, and a fluid 4. The metal layer 3 is formed on the entire outer circumferential surface 2a of the hollow bead 2. The fluid 4 is contained in an internal space 2b of the hollow bead 2.

The hollow bead 2 is formed of a thermoplastic resin. Examples of the thermoplastic resin include polyethylene (PE), polypropylene (PP), acrylic resin (methacrylic acid methyl ester, PMMA), polyamide (PA), acrylonitrile butadiene styrene (ABS), polyethyleneterephthalate (PET), polyacetal (POM), or the like.

Since the hollow bead 2 is formed of a thermoplastic resin and contains the fluid 4, the hollow bead 2 expands due to heating. It is preferable that the hollow bead 2 expands by heating at a temperature of 100° C. or higher. By heating to 100° C. or higher, the fluid 4 in the internal space 2b of the hollow bead 2 expands, and the hollow bead 2 also expands. In addition, the hollow bead 2 expanded by heating maintains its expansion shape even when the temperature is lowered.

It is preferable that the hollow bead 2 has an average grain diameter (D50) of 50 μm or less before heating, and preferably an average grain diameter (D50) of more than 50 μm and 200 μm or less after heating. That is, it is more preferable that the hollow bead 2 has a volume expansion rate by heating of 10% or more and 300% or less. Accordingly, the metal-coated hollow bead 1 has a second volume after heating larger than a first volume before heating. If the average grain diameter (D50) of the hollow bead 2 before heating exceeds 50 μm, for example, when the plurality of metal-coated hollow beads 1 disposed in the void between the two members is heated, the void between the metal-coated hollow beads 1 expanded by heating becomes larger. For this reason, after expansion, the pressure applied by the metal-coated hollow beads 1 to the two members becomes uneven.

The metal layer 3 contains at least one selected from copper, aluminum, nickel, tin, silver and gold. The metal layer 3 may be composed of only one of these metals, or may be composed of two or more of them.

Since the metal layer 3 contains at least one selected from copper, aluminum, nickel, tin, silver and gold, the heat dissipation and thermal conductance of the metal layer 3 are improved, making it possible to suppress heat rise, and when the metal-coated hollow beads 1 are heated, the heat is transferred evenly throughout the metal-coated hollow beads 1. In addition, since the rigidity of the metal-coated hollow beads 1 also increases, and for example, when the metal-coated hollow beads 1 disposed in the void between the two members are heated, the metal-coated hollow beads 1 after expansion pressurize the two members and can hold one member against the other member. The metal-coated hollow beads 1 have higher rigidity, holding power, and pressure compared to the hollow beads without the metal layer.

A thickness of the metal layer 3 is defined by the following Equation (1).

(Thickness of metal layer)/(thickness of outer shell of hollow beads)≤{(Young's Modulus of thermoplastic resin layer)/(Young's Modulus of metal layer)}^{1/3} (1)

By defining the thickness of the metal layer 3 using the above-mentioned Equation (1), since the hollow bead 2 expands due to heating and the metal layer 3 also elongates, the diameter of the hollow bead 2 can be increased without the metal layer 3 peeling from the hollow bead 2.

Here, preferred combinations of the material of the hollow bead 2 and the material of the metal layer 3 include, for example, the material of the metal layer 3/the material of the hollow bead 2=nickel/polyethyleneterephthalate, tin/polypropylene, copper/polyamide, tin/polyethylene, or the like. The preferred thickness ratios ((thickness of metal layer)/(thickness of outer shell of hollow bead)) for these combinations are shown in Table 1.

By calculating the thickness of the metal layer 3 using the values in Table 1, the metal layer 3 can be elongated as the hollow bead 2 expands by heating, and the beads diameter can be increased while suppressing peeling of the metal layer 3.

TABLE 1

| | Plating material/hollow bead material | | | | |
|---|---|---|---|---|---|
| | Ni/PET | Sn/PP | Cu/PA | Sn/PE | Sn/PS |
| Thickness ratio (thick- | 0.27 or | 0.30 or | 0.29 or | 0.26 or | 0.39 or |
| ness of metal layer)/ | less | less | less | less | less |
| (thickness of outer shell | | | | | |
| of hollow bead) | | | | | |

A gas or liquid is used as the fluid 4. Examples of the gas include neutral gases such as air and nitrogen gas, and inert gases such as argon and helium. Among these, nitrogen gas is preferred. If the fluid is nitrogen gas, when the temperature of the battery equipped with the metal-coated hollow beads 1 rises above a predetermined temperature, the metal-coated hollow beads 1 rupture to fill the battery with nitrogen and block oxygen, thereby delaying the time to ignition and suppressing spread of fire caused by ignition. Examples of the liquid include low boiling point solvents such as ethylene carbonate and propylene carbonate, which have a boiling point of about 110° C. to 170° C.

It is preferable that the metal-coated hollow beads 1 contain a material in the internal space 2b of the hollow bead 2 that expands the hollow bead 2 by a phase change. Here, the phase change refers to a thermal change or the like.

According to the metal-coated hollow beads 1 of the embodiment, for example, when the metal-coated hollow beads 1 disposed in the void between the two members are heated, the metal-coated hollow beads 1 after expansion pressurize the two members and can hold one member against the other member. Specifically, as described above, by disposing the metal-coated hollow beads 1 in the void between the can body 110 and the electrode laminate 120 and filling the void with the metal-coated hollow beads 1, the beads act as cushions for the electrode laminate 120, thereby suppressing damage to the electrode laminate 120.

When thermoplastic resin materials such as polypropylene, polystyrene, polyethyleneterephthalate, and the like, or glass materials are heated and the temperature rises, there is a temperature at which the storage elasticity/Young's Modulus becomes very small and the material shows large elongation at low stress. This temperature is referred to as the glass transition point. If the resin material is greatly deformed to the glass transition point or higher and the temperature is lowered at this deformation amount, the deformation state of the resin material can be maintained. This type of shape retention function is referred to as a shape memory effect. If this phenomenon is applied to the metal-coated hollow beads 1, normal elastic deformation occurs below the glass transition point, but ultra-elastic deformation (large deformation at low stress) occurs above the glass transition point, and the metal-coated hollow beads 1 are greatly expanded. If the temperature is lowered from this state, the expansion diameter becomes slightly smaller in proportion to the decrease in internal pressure, and when the temperature drops to the glass transition point or lower, it transits to a state in which the storage elasticity/Young's Modulus is large while maintaining the deformation amount same as when the temperature was slightly higher than the glass transition point, and the large deformation amount is fixed (shape memory effect). Accordingly, even if the temperature is lowered to the glass transition point or more, the material will not return to its original state before heating. The shape memory materials (metal, resin) take advantage of such properties.

### [Filling Member]

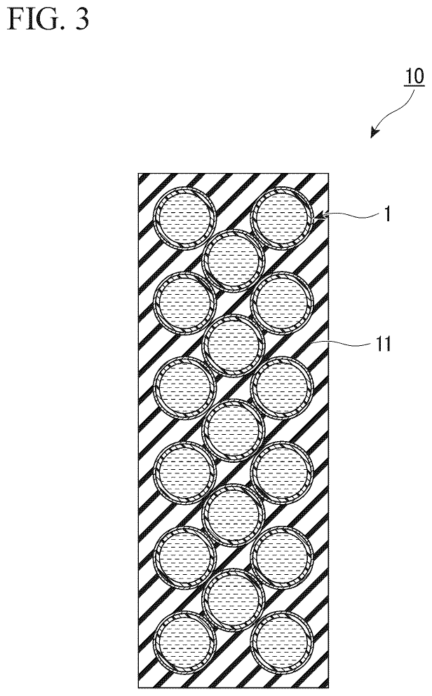

FIG. 3 is a cross-sectional view showing a filling member according to the second embodiment of the present invention.

As shown in FIG. 3, the filling member 10 of the embodiment has a rubber elastic body 11, and the metal-coated hollow beads 1 of the above-mentioned embodiment. The metal-coated hollow beads 1 is contained in the rubber elastic body 11.

The rubber elastic body 11 is preferably made of urethane rubber or silicone rubber. When the rubber elastic body 11 is made of urethane rubber or silicone rubber, the metal-coated hollow beads 1 can be prevented from being crushed within the rubber elastic body 11.

It is preferable that the elasticity of the rubber elastic body 11 is lower than the elasticity of the metal-coated hollow beads 1. Under a normal state (state before heating), if the elasticity of the rubber elastic body 11 is lower than that of the metal-coated hollow beads 1, the metal-coated hollow beads 1 can be prevented from being crushed within the rubber elastic body 11. In a state after heating, in addition to this, the metal-coated hollow beads 1 themselves can expand and rupture around the predetermined temperature of the thermal runaway.

It is preferable that the thickness of the rubber elastic body 11 is greater than 50 μm. If the thickness of the rubber elastic body 11 is less than 50 μm, the rubber elastic body 11 cannot stand on its own, and uniform pressure cannot be applied when heated due to folds or creases, which may lead to damage.

The content of the metal-coated hollow beads 1 in the rubber elastic body 11 is preferably 40% by volume or more and 80% by volume or less. If the content of the metal-coated hollow beads 1 is less than 40% by volume, the metal-coated hollow beads 1 cannot expand within the rubber elastic body 11 because they are defeated by the expansion force of the rubber elastic body 11. When the content of the metal-coated hollow beads 1 exceeds 80% by volume, the amount of the rubber elastic body 11 decreases and the filling member cannot stand on its own. In addition, by adjusting the content of the metal-coated hollow beads 1, the expansion rate of the filling member 10 can be controlled.

According to the filling member 10 of the embodiment, for example, when the filling member 10 disposed in the void between the two members is heated, the filling member 10 after expansion pressurizes the two members and can hold one member against the other member.

### [Can Type Battery]

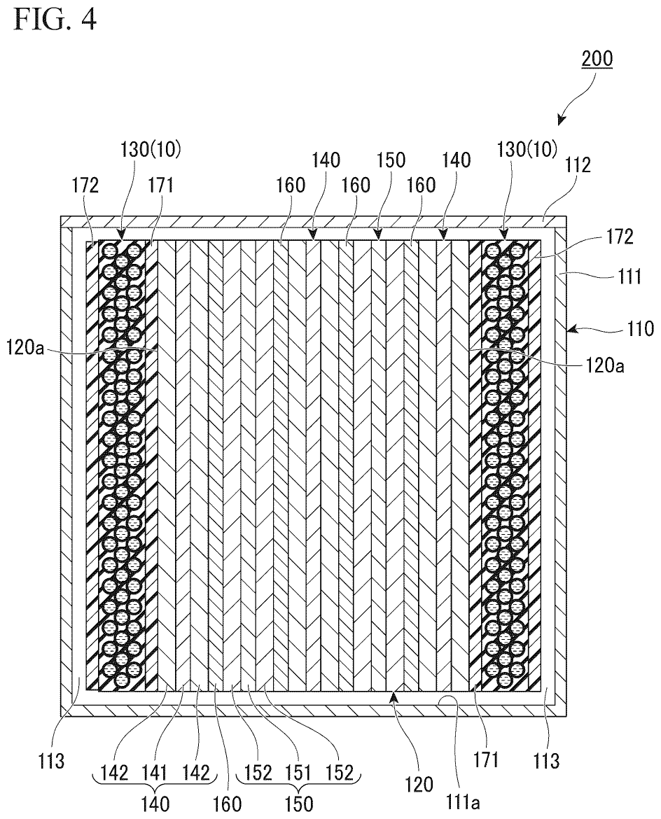

FIG. 4 is a cross-sectional view showing a can type battery according to a fourth embodiment of the present invention. In FIG. 4, the same components as those shown in FIG. 1 are designated by the same reference numerals, and the description thereof will be omitted.

As shown in FIG. 4, a can type battery 200 of the embodiment includes a can body 110, an electrode laminate 120, and a holding member 130. In the can type battery 200 of the embodiment, the holding member 130 is constituted by the filling member 10 of the embodiment described above.

According to the can type battery 200 of the embodiment, the same effects as the can type battery 100 of the above-mentioned first embodiment can be obtained.

Hereinabove, while the embodiment of the present invention has been described in detail, the present invention is not limited to the above embodiment, and various deformations and modifications are possible within the scope of the present invention described in the claims.

### Example

Hereinafter, the present invention will be described more specifically with reference to an example, but the present invention is not limited to the following example.

### Example

A microbubble generator was placed in water to generate nitrogen microbubbles in the water. Nitrogen-containing hollow beads were prepared by adding styrene monomer and a polymerization initiator to water containing nitrogen microbubbles under stirring. Polymerization of styrene monomer was initiated at the interface between the water and nitrogen, resulting in nitrogen-containing hollow beads with a particle diameter of 50 μm.

The surfaces of the obtained nitrogen-containing hollow beads were then plated with tin by the plating method, obtaining metal-coated hollow beads with a tin-plated layer formed on the surface of the nitrogen-containing hollow beads.

The obtained metal-coated hollow beads and the electrode laminate were placed in a can body. A ratio of the metal-coated hollow beads to the total volume of the void between the can body and the electrode laminate (100% by volume) was 62% by volume.

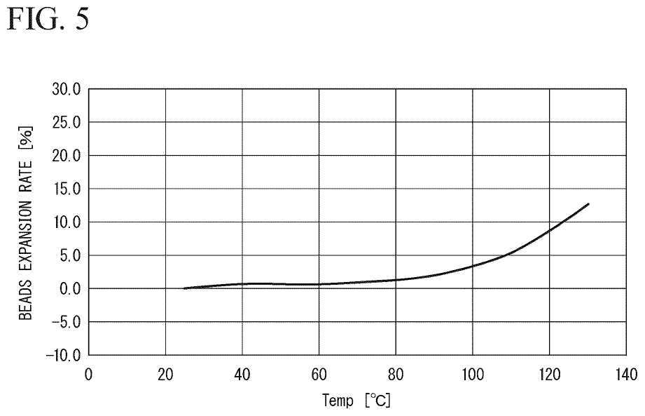

The expansion rate of the metal-coated hollow beads was measured while the temperature was changed from a room temperature (25° C.) to 130° C. by heating the metal-coated hollow beads in the container. The results are shown in FIG. 5.

From the results shown in FIG. 5, it was found that the expansion rate of the metal-coated hollow beads increased at temperatures of 100° C. or higher, and the expansion rate was 5% or more compared to the state before heating.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A can type battery comprising:
an electrode laminate accommodated in a can body and constituted by a positive electrode, a negative electrode and an electrolyte layer; and
a holding member disposed in a void between the can body and the electrode laminate and configured to hold the electrode laminate in the can body,
wherein the holding member includes a hollow bead formed of a thermoplastic resin, a metal layer formed on an outer circumferential surface of the hollow bead, and a fluid contained in an internal space of the hollow beads, and is a filling member that includes a metal-coated hollow bead contained in the rubber elastic body, wherein the metal-coated hollow bead or the rubber elastic body has a second volume after heating which is greater than a first volume before heating and, pressurizes the laminate in a laminating direction due to an increase in volume of the metal-coated hollow bead or the rubber elastic body.

2. The can type battery according to claim 1, wherein an insulating body is disposed at least one of between the electrode laminate and the holding member and between the can body and the holding member.

3. The can type battery according to claim 2, wherein the insulating body is a film or a sheet formed of at least one selected from polyethylene, polypropylene, polyethyleneterephthalate, polyamide, polyamideimide, polyvinylidene fluoride and polytetrafluoroethylene.

4. The can type battery according to claim 1, wherein the electrolyte layer is a solid electrolyte layer.

5. The can type battery according to claim 1, wherein the fluid is nitrogen gas.

6. The can type battery according to claim 1, wherein the hollow bead has an expansion temperature of 100° C. or higher by heating.

7. The can type battery according to claim 1, wherein the metal layer contains at least one selected from copper, aluminum, nickel, tin, silver and gold.

8. The can type battery according to claim 7, wherein a thickness of the metal layer is defined by the following Equation (1).
(Thickness of metal layer)/(thickness of outer shell of hollow bead)≤{(Young's Modulus of thermoplastic resin layer)/(Young's Modulus of metal layer)}^{1/3} (1)

9. The can type battery according to claim 1, wherein the hollow bead has an average grain diameter (D50) of 50 μm or less before heating, and an average grain diameter (D50) of more than 50 μm and 200 μm or less after heating.

10. The can type battery according to claim 1, wherein the rubber elastic body is constituted by a urethane rubber or a silicone rubber.

11. The can type battery according to claim 10, wherein an elasticity of the rubber elastic body is lower than that of the metal-coated hollow bead.

12. The can type battery according to claim 1, wherein a thickness of the rubber elastic body is 50 μm or more.

13. The can type battery according to claim 1, wherein a content of the metal-coated hollow bead in the filling member is 40% by volume or more and 80% by volume or less.

14. A method of manufacturing a can type battery comprising:
a process of disposing an electrode laminate constituted by a positive electrode, a negative electrode and an electrolyte layer in a can body;
a process of disposing a holding member in a void between the can body and the electrode laminate; and
a process of heating and expanding the holding member, pressurizing the electrode laminate against the holding member in a laminating direction, and holding the electrode laminate in the can body with the holding member,
wherein the holding member includes a hollow bead formed of a thermoplastic resin, a metal layer formed on an outer circumferential surface of the hollow bead, and a fluid contained in an internal space of the hollow beads, and is a filling member that includes a metal-coated hollow bead contained in the rubber elastic body, wherein the metal-coated hollow bead or the rubber elastic body has a second volume after heating which is greater than a first volume before heating and, pressurizes the laminate in a laminating direction due to an increase in volume of the metal-coated hollow bead or the rubber elastic body.

15. The method of manufacturing a can type battery according to claim 14, further having a process of disposing an insulating body at least one of between the electrode laminate and the holding member and between the can body and the holding member before the process of disposing the electrode laminate.

16. The method of manufacturing a can type battery according to claim 14, further having a process of disposing an insulating body configured to cover an electrode surface of the electrode laminate before the process of disposing the electrode laminate.
